(19) United States
(12) Patent Application Publication
(10) Pub. No.: US 2016/0073087 A1
(43) Pub. Date: Mar. 10, 2016

(54) AUGMENTING A DIGITAL IMAGE WITH DISTANCE DATA DERIVED BASED ON ACOUSTIC RANGE INFORMATION

(71) Applicant: Lenovo (Singapore) Pte. Ltd., New Tech Park (SG)

(72) Inventors: Mark Charles Davis, Durham, NC (US); John Weldon Nicholson, Cary, NC (US)

(21) Appl. No.: 14/482,838

(22) Filed: Sep. 10, 2014

(51) Int. Cl. H04N 13/02; G06K 9/46; G06T 7/00; G06F 3/01; G06K 9/62; G06K 9/52; H04N 5/225; G02B 13/00; G01B 11/14; H04N 5/265

(52) U.S. Cl. CPC H04N 13/0203; G01B 11/14; G06K 9/46; G06T 7/0097; H04N 5/265; G06K 9/6218; G06K 9/52; H04N 5/2254; G02B 13/0015; G06F 3/017

(57) ABSTRACT

Methods, devices and program products are provided that capture image data at an image capture device for a scene, collect acoustic data indicative of a distance between the image capture device and an object in the scene, designate a range in connection with the object based on the acoustic data, and combine a portion of the image data related to the object with the range to form a 3D image data set. The device comprises a processor, a digital camera, a data collector, and a local storage medium storing program instructions accessible by the processor. The processor combines the image data related to the object with the range to form a 3D image data set.

### FIELD

The present disclosure relates generally to augmenting an image using distance data derived from acoustic range information.

### BACKGROUND OF THE INVENTION

In three-dimensional (3D) imaging, it is often desirable to represent objects in an image as three-dimensional (3D) representations that are close to their real-life appearance. However, there are currently no adequate, cost effective devices for doing so, much less ones that have ample range and depth resolution capabilities.

### SUMMARY

In accordance with an embodiment, a method is provided which comprises capturing image data at an image capture device for a scene, and collecting acoustic data indicative of a distance between the image capture device and an object in the scene. The method also comprises designating a range in connection with the object based on the acoustic data; and combining a portion of the image data related to the object with the range to form a 3D image data set.

Optionally, the method may further comprise identifying object-related data within the image data as the portion of the image data, the object-related data being combined with the range. Alternatively, the method may further comprise segmenting the acoustic data into sub-regions of the scene and designating a range for each of the sub-regions. Optionally, the method may further comprise performing object recognition for objects in the image data by: analyzing the image data for candidate objects; discriminating between the candidate objects based on the range to designate a recognized object in the image data.

Optionally, the method may include the image data comprising a matrix of pixels that define an image frame, the method further comprising analyzing the pixels to perform object recognition of objects within the image frame to form object segments within the image frame, the designating operation including associating individual ranges with the corresponding object segments. Alternatively, the method include the acoustic data comprising a matrix of acoustic ranges within an acoustic data frame, each of the acoustic ranges indicative of the distance between the image capture device and the corresponding object. Optionally, the method may further comprise: segmenting the acoustic data into sub-regions, where each of the sub-regions has at least one corresponding range assigned thereto; overlaying the pixels of the image data and the sub-regions to form pixel clusters associated with the sub-regions; and assigning the ranges to pixel clusters such that each of the pixel clusters is assigned the range associated with a sub-region of the acoustic data that overlays the pixel cluster.

Alternatively, the method may include the acoustic data comprising sub-regions and wherein the image data comprises pixels grouped into pixel clusters aligned with the sub-regions, assigning to each pixel the range associated with the sub-region aligned with the pixel cluster. Optionally, the method may include the 3D image data set including a plurality of 3D image frames, the method further comprising comparing positions of the objects, based at least in part on the corresponding ranges, between the 3D image frames to identify motion of the objects. Alternatively, the method may further comprise detecting a gesture-related movement of the object based at least in part on changes in the range to the object between frames of the 3D image data set.

In accordance with an embodiment, a device is provided, which comprises a processor and a digital camera that captures image data for a scene. The device also comprises an acoustic data collector that collects acoustic data indicative of information regarding a distance between the digital camera and an object in the scene and a local storage medium storing program instructions accessible by the processor. The processor, responsive to execution of the program instructions, combines the image data related to the object with the information to form a 3D image data set.

Optionally, the device may further comprise a housing, the digital camera including a lens, the acoustic data collector including a plurality of transceivers, the lens and transceivers mounted in a common side of the housing to be directed in a common viewing direction. Alternatively, the device may include transceivers and a beam former communicatively coupled to the transceivers, the beam former to transmit acoustic beams toward the scene and receive acoustic reflections from the object in the scene, the beam former to generate the acoustic data based on the acoustic reflections. Optionally, the processor may designate a range in connection with the object based on the acoustic data, the range representing at least a portion of the information combined with the image data to form the 3D image data set.

The acoustic data collector may comprise a beam former configured to direct the transceivers to perform multiline reception along multiple receive beams to collect the acoustic data. The acoustic data collector may align transmission and reception of the acoustic transmit and receiving beams to occur overlapping in time with collection of the image data.

In accordance with an embodiment, a computer program product is provided, comprising a non-transitory computer readable medium having computer executable code to perform operations. The operations comprise capturing image data at an image capture device for a scene, collecting acoustic data indicative of a distance between the image capture device and an object in the scene, and combining a portion of the image data related to the object with the range to form a 3D image data set.

Optionally, the computer executable code may designate a range in connection with the object based on the acoustic data. Alternatively, the computer executable code may segment the acoustic data into sub-regions of the scene and designate a range for each of the sub-regions. Optionally, the code may perform object recognition for objects in the image data by: analyzing the image data for candidate objects and discriminating between the candidate objects based on the range to designate a recognized object in the image data.

### BRIEF DESCRIPTION OF THE DRAWINGS

FIG. 1 illustrates a system for generating three-dimensional (3-D) images in accordance with embodiments herein.

FIG. 2A illustrates a simplified block diagram of the image capture device of FIG. 1 in accordance with an embodiment.

FIG. 2B is a functional block diagram illustrating the hardware configuration of a camera device implemented in accordance with an alternative embodiment.

FIG. 3 illustrates a functional block diagram illustrating a schematic configuration of the camera unit in accordance with embodiments herein.

FIG. 4 illustrates a schematic block diagram of an ultrasound unit for transmitting ultrasound waves and receiving ultrasound reflections in accordance with embodiments herein.

FIG. 5 illustrates a process for generating three-dimensional image data sets in accordance with embodiments herein.

FIG. 6A illustrates the process performed in accordance with embodiments herein to apply range data to object segments of the image data.

FIG. 6B illustrates a process for identifying motion of objects of interest within a 3-D image data set in accordance with embodiments herein.

FIG. 7 illustrates an image data frame and an acoustic data frame collected simultaneously or contemporaneously (e.g., overlapping in time) in connection with a single scene in accordance with embodiments herein.

FIG. 8 illustrates alternative configurations for the transceiver array in accordance with alternative embodiments.

FIG. 9 illustrates an example UI presented on a device such as the system in accordance with embodiments herein.

FIG. 10 illustrates example settings UI for configuring settings of a system in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

### System Overview

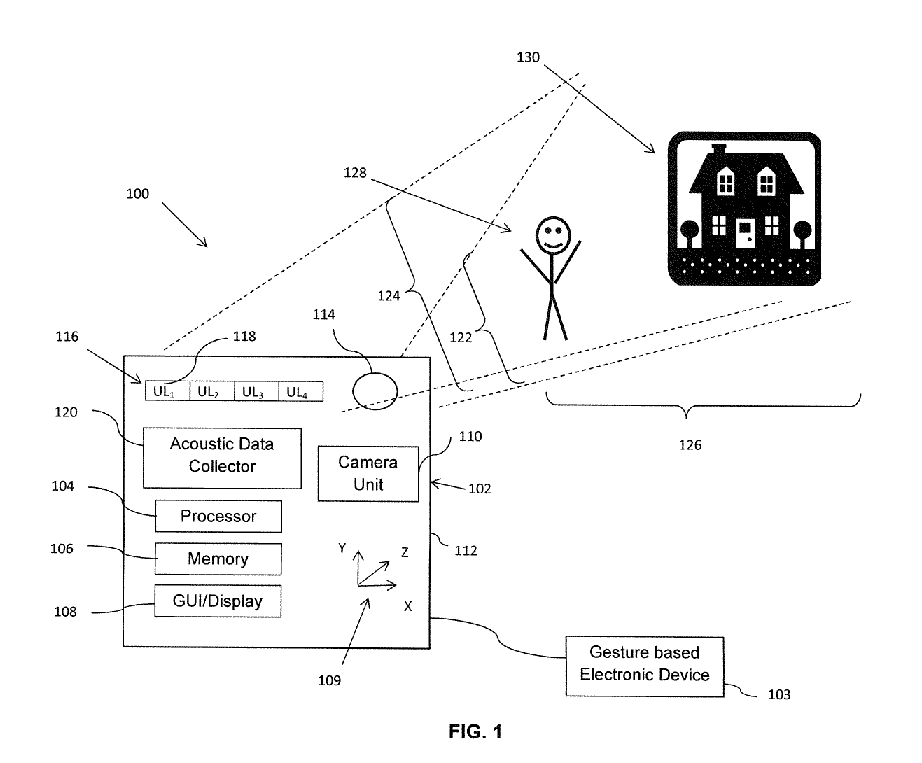

FIG. 1 illustrates a system 100 for generating three-dimensional (3-D) images in accordance with embodiments herein. The system 100 includes a device 102 that may be stationary or portable/handheld. The device 102 includes, among other things, a processor 104, memory 106, and a graphical user interface (including a display) 108. The device 102 also includes a digital camera unit 110 and an acoustic data collector 120.

The device 102 includes a housing 112 that holds the processor 104, memory 106, GUI 108, digital camera unit 110 and acoustic data collector 120. The housing 112 includes at least one side, within which is mounted a lens 114. The lens 114 is optically and communicatively coupled to the digital camera unit 110. The lens 114 has a field of view 122 and operate under control of the digital camera unit 110 in order to capture image data for a scene 126.

In accordance with embodiments herein, device 102 detects gesture related object movement for one or more objects in a scene based on XY position information (derived from image data) and Z position information (indicated by range values derived from acoustic data). In accordance with embodiments herein, the device 102 collects a series of image data frames associated with the scene 126 over time. The device 102 also collects a series of acoustic data frames associated with the scene over time. The processor 104 combines range values, from the acoustic data frames, with the image data frames to form three-dimensional (3-D) data frames. The processor 104 analyzes the 3-D data frames, to detect positions of objects (e.g. hands, fingers, faces) within each of the 3-D data frames. The XY positions of the objects are determined from the image data frames, where the position is designated with respect to a coordinate reference system (e.g. an XYZ reference point in the scene or reference point on the digital camera unit 110). The positions of the objects are determined from the acoustic data frames where the Z position is designated with respect to the coordinate reference system.

The processor 104 compares positions of objects between successive 3-D data frames to identify movement of one or more objects between the successive 3-D data frames. Movement in the XY direction is derived from the image data frames, while the movement in the Z direction is derived from the range values derived from the acoustic data frames.

For example, the device 102 may be implemented in connection with detecting gestures of a person, where such gestures are intended to provide direction or commands for another electronic system 103. For example, the device 102 may be implemented within, or communicatively coupled to, another electronic system 103 (e.g. a videogame, a smart TV, a web conferencing system and the like). The device 102 provides gesture information to a gesture driven/commanded electronic system 103. For example, the device 102 may provide the gesture information to the gesture driven/commanded electronic system 103, such as when playing a videogame, controlling a smart TV, making a presentation during an interactive web conferencing event, and the like.

An acoustic transceiver array 116 is also mounted in the side of the housing 112. The transceiver array 116 includes one or more transceivers 118 (denoted in FIG. 1 as UL1-UL4). The transceivers 118 may be implemented with a variety of transceiver configuration that perform range determinations. Each of the transceivers 118 may be utilized to both transmit and receive acoustic signals. Alternatively, one or more individual transceivers 118 (e.g. UL1) may be designated as a dedicated omnidirectional transmitter, one or more of the remaining transceivers 118 (e.g. UL2-4) may be designated as dedicated receivers. When using a dedicated transmitter and dedicated receivers, the acoustic data collector 120 may perform parallel processing in connection with transmit and receive, even while generating multiple receive beams which may increase a speed at which the device 102 may collect acoustic data and convert image data into a three-dimensional picture.

Alternatively, the transceiver array 116 may be implemented with transceivers 118 that perform both transmit and receive operations. Arrays 116 that utilize transceivers 118 for both transmit and receive operations are generally able to remove more background noise and exhibit higher transmit powers. The transceiver array 116 may be configured to focus one or more select transmit beams along select firing lines within the field of view. The transceiver array 116 may also be configured to focus one or more receive beams along select receive or reception lines within the field of view. When using multiple focused transmit beams and/or focused receive beams, the transceiver array 116 will utilize lower power and collect less noise, as compared to at least some other transmit and receive configurations. When using multiple focused transmit beams and/or multiple focused receive beams, the transmit and/or receive beams are steered and swept across the scene to collect acoustic data for different regions that can be converted to range information at multiple points or subregions over the field of view. When an omnidirectional transmit transceiver is used in combination with multiple focused receive lines, the system collects less noise during the receive operation, but still uses a certain amount of time in order for the receive beams to sweep across the field of view.

The transceivers 118 are electrically and communicatively coupled to a beam former in the acoustic data collection unit 120. The lens 114 and transceivers 118 are mounted in a common side of the housing 112 and are directed/oriented to have a common viewing direction, namely a field of view that is common and overlapping. The beam former directs the transceiver array 116 to transmit acoustic beams that propagate as acoustic waves (denoted at 124) toward the scene 126 within the field of view of the lens 114. The transceiver array 116 receives acoustic echoes or reflections from objects 128, 130 within the scene 126.

The beam former processes the acoustic echoes/reflections to generate acoustic data. The acoustic data represents information regarding distances between the device 102 and the objects 128, 130 in the scene 126. As explained below in more detail, in response to execution of program instructions stored in the memory 106, the processor 104 processes the acoustic data to designate range(s) in connection with the objects 128, 130 in the scene 126. The range(s) are designated based on the acoustic data collected by the acoustic data collector 120. The processor 104 uses the range(s) to modify image data collected by the camera unit 110 to thereby update or form a 3-D image data set corresponding to the scene 126. The ranges and acoustic data represent information regarding distances between the device 102 and objects in the scene.

In the example of FIG. 1, the acoustic transceivers 118 are arranged along one edge of the housing 11.2. For example, when the device 102 is a notebook device or tablet device or smart phone, the acoustic transceivers 118 may be arranged along an upper edge adjacent to the lens 114. As one example, the acoustic transceivers 118 may be provided in the bezel of the smart phone, notebook device, tablet device and the like.

The transceiver array 116 may be configured to have various fields of view and ranges. For example, the transceiver array 116 may be provided with a 60° field of view centered about a line extending perpendicular to the center of the transceiver array 116. As another example, the field of view of the transceiver array 116 may extend 5-20°, or preferably 5-35°, to either side of an axis extending perpendicular to the center of the transceiver array 116 (corresponding to surface of the housing 112).

The transceiver array 116 may transmit and receive at acoustic frequencies of up to about 100 KHz, or approximately between 30-100 KHz, or approximately between 40-60 KHz. The transceiver array 116 may measure various ranges or distances from the lens 114. For example, the transceiver array 116 may have an operating resolution of within 1 inch. In other words, the transceiver array 116 may be able to provide acoustic data (useful in updating the image data as explained herein) indicative of distance to objects of interest within 1 millimeter of accuracy. The transceiver array 116 may have an operating far field range/distance of up to 3 feet, 10 feet, 30 feet, 25 yards or more. In other words, the transceiver array 116 may be able to provide acoustic data (useful in updating the image data as explained herein) indicative of distance to objects of interest that are as far away as the noted ranges/distances.

The system 100 may calibrate the acoustic data collector 120 and the camera unit 110 to a common reference coordinate system in order that acoustic data collected within the field of view can be utilized to assign ranges to individual pixels within the image data collected by the camera unit 110. The calibration may be performed through mechanical design or may be adjusted initially or periodically, such as in connection with configuration measurements. For example, a phantom (e.g. one or more predetermined objects spaced in a known relation to a reference point) may be placed a known distance from the lens 114. The camera unit 110 then obtains an image data frame of the phantom and the acoustic data collector 120 obtains acoustic data indicative of distances to the objects in the phantom. The calibration image data frame and calibration acoustic data are analyzed to calibrate the acoustic data collector 120.

FIG. 1 illustrates a reference coordinate system 109 to which the camera unit 110 and acoustic data collector 120 may be calibrated. When image data is captured, the resulting image data frames are stored relative to the reference coordinate system 109. For example, each image data frame may represent a two-dimensional array of pixels (e.g. having an X axis and a Y axis) where each pixel has a corresponding color as sensed by sensors of the camera unit 110. When the acoustic data is captured and range values calculated therefrom, the resulting range values are stored relative to the reference coordinate system 109. For example, each range value may represent a range or depth along the Z axis. When the range and image data are combined, the resulting 3-D data frames include three-dimensional distance information (X, Y and Z values with respect to the reference coordinate system 109) plus the color associated with each pixel.

### Image Capture Device

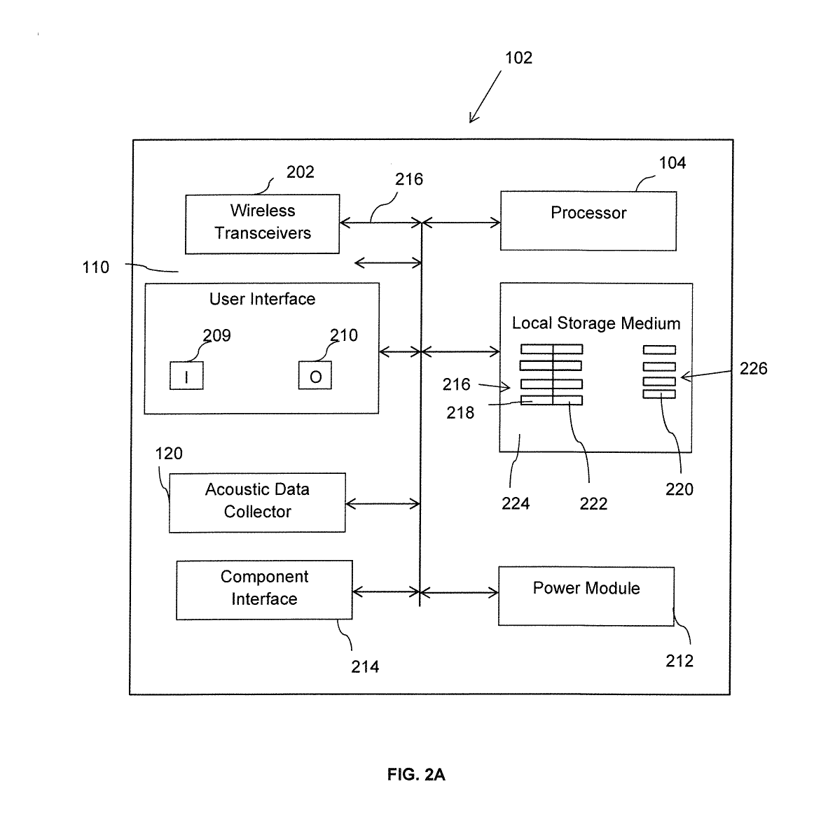

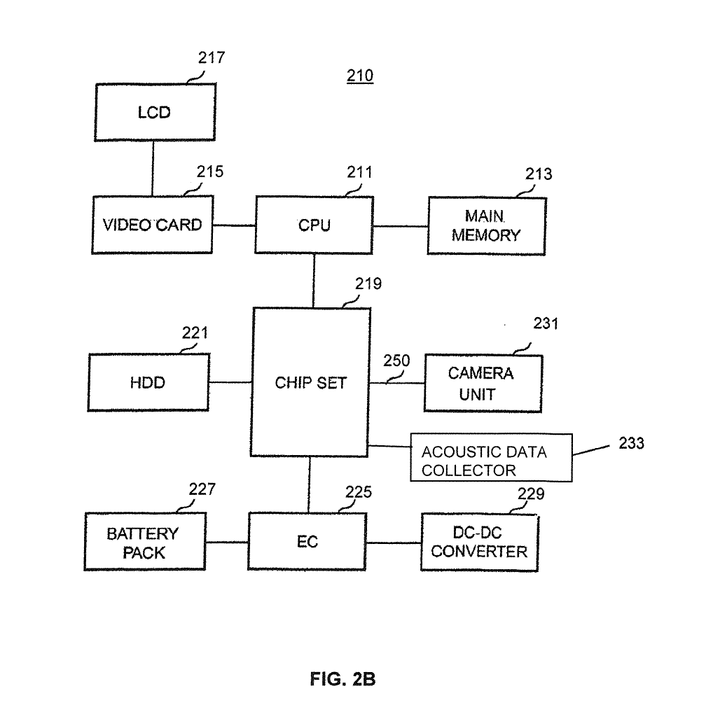

FIG. 2A illustrates a simplified block diagram of the image capture device 102 of FIG. 1 in accordance with an embodiment. The image capture device 102 includes components such as one or more wireless transceivers 202, one or more processors 104 (e.g., a microprocessor, microcomputer, application-specific integrated circuit, etc.), one or more local storage medium (also referred to as a memory portion) 106, the user interface 108 which includes one or more input devices 209 and one or more output devices 210, a power module 212, and a component interface 214. The device 102 also includes the camera unit 110 and acoustic data collector 120. All of these components can be operatively coupled to one another, and can be in communication with one another, by way of one or more internal communication links 216, such as an internal bus.

The input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof.

The user interface 108 permits the user to select one or more of a switch, button or icon to collect content elements, and/or enter indicators to direct the camera unit 110 to take a photo or video (e.g., capture image data for the scene 126). As another example, the user may select a content collection button on the user interface 2 or more successive times, thereby instructing the image capture device 102 to capture the image data.

As another example, the user may enter one or more predefined touch gestures and/or voice command through a microphone on the image capture device 102. The predefined touch gestures and/or voice command may instruct the image capture device 102 to collect image data for a scene and/or a select object (e.g. the person 128) in the scene.

The local storage medium 106 can encompass one or more memory devices of any of a variety of forms (e.g., read only memory, random access memory, static random access memory, dynamic random access memory, etc.) and can be used by the processor 104 to store and retrieve data. The data that is stored by the local storage medium 106 can include, but need not be limited to, operating systems, applications, user collected content and informational data. Each operating system includes executable code that controls basic functions of the device, such as interaction among the various components, communication with external devices via the wireless transceivers 202 and/or the component interface 214, and storage and retrieval of applications and data to and from the local storage medium 106. Each application includes executable code that utilizes an operating system to provide more specific functionality for the communication devices, such as file system service and handling of protected and unprotected data stored in the local storage medium 106.

As explained herein, the local storage medium 106 stores image data 216, range information 222 and 3D image data 226 in common or separate memory sections. The image data 216 includes individual image data frames 218 that are captured when individual pictures of scenes are taken. The data frames 218 are stored with corresponding acoustic range information 222. The range information 222 is applied to the corresponding image data frame 218 to produce a 3-D data frame 220. The 3-D data frames 220 collectively form the 3-D image data set 226.

Additionally, the applications stored in the local storage medium 106 include an acoustic based range enhancement for 3D image data (UL-3D) application 224 for facilitating the management and operation of the image capture device 102 in order to allow a user to read, create, edit, delete, organize or otherwise manage the image data, acoustic data, range information and the like. The UL-3D application 224 includes program instructions accessible by the one or more processors 104 to direct a processor 104 to implement the methods, processes and operations described herein including, but not limited to the methods, processes and operations illustrated in the Figures and described in connection with the Figures.

Other applications stored in the local storage medium 106 include various application program interfaces (APIs), some of which provide links to/from the cloud hosting service 102. The power module 212 preferably includes a power supply, such as a battery, for providing power to the other components while enabling the image capture device 102 to be portable, as well as circuitry providing for the battery to be recharged. The component interface 214 provides a direct connection to other devices, auxiliary components, or accessories for additional or enhanced functionality, and in particular, can include a USB port for linking to a user device with a USB cable.

Each transceiver 202 can utilize a known wireless technology for communication. Exemplary operation of the wireless transceivers 202 in conjunction with other components of the image capture device 102 may take a variety of forms and may include, for example, operation in which, upon reception of wireless signals, the components of image capture device 102 detect communication signals and the transceiver 202 demodulates the communication signals to recover incoming information, such as voice and/or data, transmitted by the wireless signals. After receiving the incoming information from the transceiver 202, the processor 104 formats the incoming information for the one or more output devices 210. Likewise, for transmission of wireless signals, the processor 104 formats outgoing information, which may or may not be activated by the input devices 210, and conveys the outgoing information to one or more of the wireless transceivers 202 for modulation to communication signals. The wireless transceiver(s) 202 convey the modulated signals to a remote device, such as a cell tower or a remote server (not shown).

FIG. 2B is a functional block diagram illustrating the hardware configuration of a camera device 210 implemented in accordance with an alternative embodiment. For example, the device 210 may represent a gaming system or subsystem of a gaming system, such as in an Xbox system, PlayStation system, Wii system and the like. As another example, the device 210 may represent a subsystem within a smart TV, a videoconferencing system, and the like. The device 210 may be used in connection with any system that captures still or video images, such as in connection with detecting user motion (e.g. gestures, commands, activities and the like).

The CPU 211 includes a memory controller and a PCI Express controller and is connected to a main memory 213, a video card 215, and a chip set 219. An LCD 217 is connected to the video card 215. The chip set 219 includes a real time clock (RTC) and SATA, USB, PCI Express, and LPC controllers. A HDD 221 is connected to the SATA controller. A USB controller is composed of a plurality of hubs constructing a USB host controller, a route hub, and an I/O port.

A camera unit 231 may be a USB device compatible with the USB 2.0 standard or the USB 3.0 standard. The camera unit 231 is connected to the USB port of the USB controller via one or three pairs of USB buses, which transfer data using a differential signal. The USB port, to which the camera device 231 is connected, may share a hub with another USB device. Preferably the USB port is connected to a dedicated hub of the camera unit 231 in order to effectively control the power of the camera unit 231 by using a selective suspend mechanism of the USB system. The camera unit 231 may be of an incorporation type in which it is incorporated into the housing of the note PC or may be of an external type in which it is connected to a USB connector attached to the housing of the note PC.

The acoustic data collector 233 may be a USB device connected to a USB port to provide acoustic data to the CPU 211 and/or chip set 219.

The system 210 includes hardware such as the CPU 211, the chip set 219, and the main memory 213. The system 210 includes software such as a UL-3D application in memory 213, device drivers of the respective layers, a static image transfer service, and an operating system. An EC 225 is a microcontroller that controls the temperature of the inside of the housing of the computer 210 or controls the operation of a keyboard or a mouse. The EC 225 operates independently of the CPU 211. The EC 225 is connected to a battery pack 227 and a DC-DC converter 229. The EC 225 is further connected to a keyboard, a mouse, a battery charger, an exhaust fan, and the like. The EC 225 is capable of communicating with the battery pack 227, the chip set 219, and the CPU 211. The battery pack 227 supplies the DC-DC converter 229 with power when an AC/DC adapter (not shown) is not connected to the battery pack 227. The DC-DC converter 229 supplies the device constructing the computer 210 with power.

### Digital Camera Module

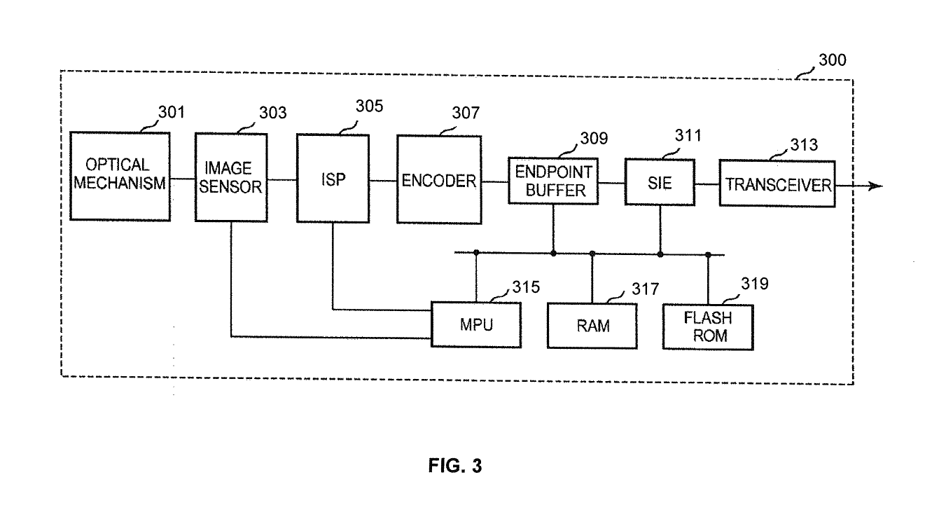

FIG. 3 is a functional block diagram illustrating a schematic configuration of the camera unit 300. The camera unit 300 is able to transfer VGA (640×480), QVGA (320×240), WVGA (800×480), WQVGA (400×240), and other image data in the static image transfer mode. An optical mechanism 301 (corresponding to lens 114 in FIG. 1) includes an optical lens and an optical filter and provides an image of a subject on an image sensor 303.

The image sensor 303 includes a CMOS image sensor that converts electric charges, which correspond to the amount of light accumulated in photo diodes forming pixels, to electric signals and outputs the electric signals. The image sensor 303 further includes a CDS circuit that suppresses noise, an AGC circuit that adjusts gain, an AD converter circuit that converts an analog signal to a digital signal, and the like. The image sensor 303 outputs digital signals corresponding to the image of the subject. The image sensor 303 is able to generate image data at a select frame rate (e.g. 30 fps).

The CMOS image sensor is provided with an electronic shutter referred to as a “rolling shutter,” The rolling shutter controls exposure time so as to be optimal for a photographing environment with one or several lines as one block. In one frame period, or in the case of an interlace scan, the rolling shutter resets signal charges that have accumulated in the photo diodes, and which form the pixels during one field period, in the middle of photographing to control the time period during which light is accumulated corresponding to shutter speed. In the image sensor 303, a CCD image sensor may be used, instead of the CMOS image sensor.

An image signal processor (ISP) 305 is an image signal processing circuit which performs correction processing for correcting pixel defects and shading, white balance processing for correcting spectral characteristics of the image sensor 303 in tune with the human luminosity factor, interpolation processing for outputting general RGB data on the basis of signals in an RGB Bayer array, color correction processing for bringing the spectral characteristics of a color filter of the image sensor 303 close to ideal characteristics, and the like. The ISP 305 further performs contour correction processing for increasing the resolution feeling of a subject, gamma processing for correcting nonlinear input-output characteristics of the LCD 37, and the like. Optionally, the ISP 305 may perform the processing discussed herein to utilize the range information derived from the acoustic data to modify the image data to form 3-D image data sets. For example, the ISP 305 may combine image data, having two-dimensional position information in combination with pixel color information, with the acoustic data, having two-dimensional position information in combination with depth/range values (Z position information), to form a 3-D data frame having three-dimensional position information associated with color information for each image pixel. The ISP 305 may then store the 3-D image data sets in the RAM 317, flash ROM 319 and elsewhere.

Optionally, additional features may be provided within the camera unit 300, such as described hereafter in connection with the encoder 307, endpoint buffer 309, SIE 311, transceiver 313 and micro-processing unit (MPU) 315. Optionally, the encoder 307, endpoint buffer 309, SIE 311, transceiver 313 and MPU 315 may be omitted entirely.

In accordance with certain embodiments, an encoder 307 is provided to compress image data received from the ISP 305. An endpoint buffer 309 forms a plurality of pipes for transferring USB data by temporarily storing data to be transferred bidirectionally to or from the system. A serial interface engine (SIE) 311 packetizes the image data received from the endpoint buffer 309 so as to be compatible with the USB standard and sends the packet to a transceiver 313 or analyzes the packet received from the transceiver 313 and sends a payload to an MPU 315. When the USB bus is in the idle state for a predetermined period of time or longer, the SIE 311 interrupts the MPU 315 in order to transition to a suspend state. The SIE 311 activates the suspended MPU 315 when the USB bus 50 has resumed.

The transceiver 313 includes a transmitting transceiver and a receiving transceiver for USB communication. The MPU 315 runs enumeration for USB transfer and controls the operation of the camera unit 300 in order to perform photographing and to transfer image data. The camera unit 300 conforms to power management prescribed in the USB standard. When being interrupted by the SIE 311, the MPU 315 halts the internal clock and then makes the camera unit 300 transition to the suspend state as well as itself.

When the USB bus has resumed, the MPU 315 returns the camera unit 300 to the power-on state or the photographing state. The MPU 315 interprets the command received from the system and controls the operations of the respective units so as to transfer the image data in the dynamic image transfer mode or the static image transfer mode. When starting the transfer of the image data in the static image transfer mode, the MPU 315 first performs the calibration of rolling shutter exposure time (exposure amount), white balance, and the gain of the AGC circuit and then acquires optimal parameter values for the photographing environment at the time, before setting the parameter values to predetermined registers for the image sensor 303 and the ISP 305.

The MPU 315 performs the calibration of exposure time by calculating the average value of luminance signals in a photometric selection area on the basis of output signals of the CMOS image sensor and adjusting the parameter values so that the calculated luminance signal coincides with a target level. The MPU 315 also adjusts the gain of the AGC circuit when calibrating the exposure time. The MPU 315 performs the calibration of white balance by adjusting the balance of an RGB signal relative to a white subject that changes according to the color temperature of the subject. The MPU 315 may also provide feedback to the acoustic data collector 120 regarding when and how often to collect acoustic data.

When the image data is transferred in the dynamic image transfer mode, the camera unit does not transition to the suspend state during a transfer period. Therefore, the parameter values once set to registers do not disappear. In addition, when transferring the image data in the dynamic image transfer mode, the MPU 315 appropriately performs calibration even during photographing to update the parameter values of the image data.

When receiving an instruction of calibration, the MPU 315 performs calibration and sets new parameter values before an immediate data transfer and sends the parameter values to the system.

The camera unit 300 is a bus-powered device that operates with power supplied from the USB bus. Note that, however, the camera unit 300 may be a self-powered device that operates with its own power. In the case of the self-powered device, the MPU 315 controls the self-supplied power to follow the state of the USB bus 50.

### Ultrasound Data Collector

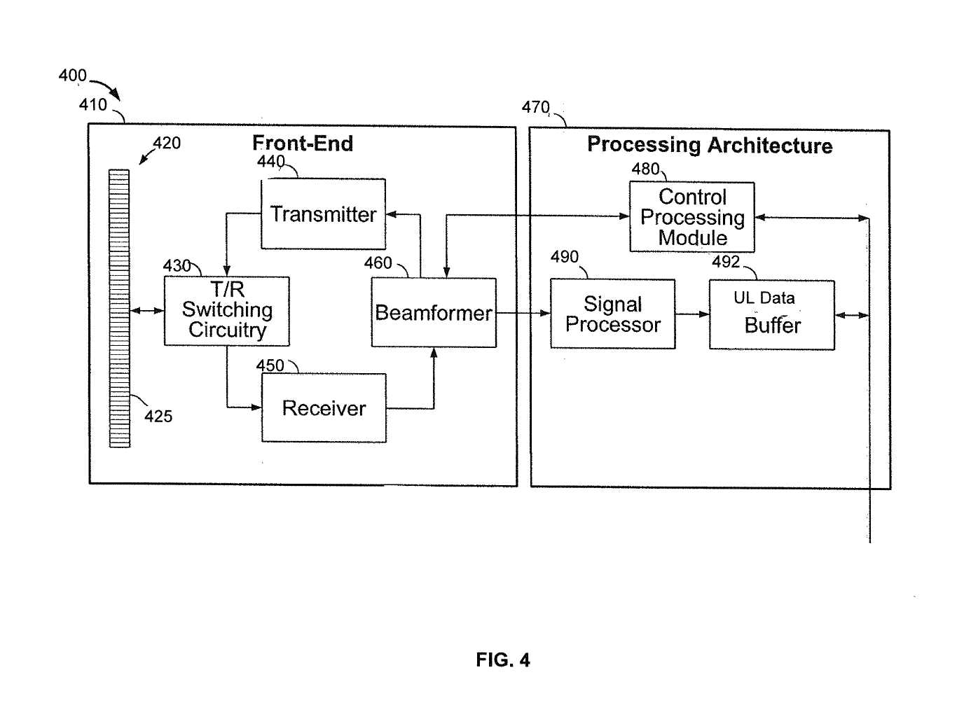

FIG. 4 is a schematic block diagram of an ultrasound unit 400 for transmitting ultrasound waves and receiving ultrasound reflections in accordance with embodiments herein. The ultrasound unit 400 may represent one example of an implementation for the acoustic data collector 120. Ultrasound transmit and receive beams represent one example of one type of acoustic transmit and receive beams. It is to be understood that the embodiments described herein are not limited to ultrasound as the acoustic medium from which range values are derived. Instead, the concepts and aspects described herein in connection with the various embodiments may be implemented utilizing other types of acoustic medium to collect acoustic data from which range values may be derived for the object or XY positions of interest within a scene. A front-end 410 comprises a transceiver array 420 (comprising a plurality of transceiver or transducer elements 425), transmit/receive switching circuitry 430, a transmitter 440, a receiver 450, and a beam former 460. Processing architecture 470 comprises a control processing module 480, a signal processor 490 and an ultrasound data buffer 492. The ultrasound data is output from the buffer 492 to memory 106, 213 or processor 104, 211, in FIGS. 1, 2A and 2B.

To generate one or more transmitted ultrasound beams, the control processing module 480 sends command data to the beam former 460, telling the beam former 460 to generate transmit parameters to create one or more beams having a defined shape, point of origin, and steering angle. The transmit parameters are sent from the beam former 460 to the transmitter 440. The transmitter 440 drives the transceiver/transducer elements 425 within the transceiver array 420 through the T/R switching circuitry 430 to emit pulsed ultrasonic signals into the air toward the scene of interest.

The ultrasonic signals are back-scattered from objects in the scene, like arms, legs, faces, buildings, plants, animals and the like to produce ultrasound reflections or echoes which return to the transceiver array 420. The transceiver elements 425 convert the ultrasound energy from the backscattered ultrasound reflections or echoes into received electrical signals. The received electrical signals are routed through the T/R switching circuitry 430 to the receiver 450, which amplifies and digitizes the received signals and provides other functions such as gain compensation.

The digitized received signals are sent to the beam former 460. According to instructions received from the control processing module 480, the beam former 460 performs time delaying and focusing to create received beam signals.

The received beam signals are sent to the signal processor 490, which prepares frames of ultrasound data. The frames of ultrasound data may be stored in the ultrasound data buffer 492, which may comprise any known storage medium.

In the example of FIG. 4, a common transceiver array 420 is used for transmit and receive operations. In the example of FIG. 4, the beam former 460 times and steers ultrasound pulses from the transceiver elements 425 to form one or more transmitted beams along a select firing line and in a select firing direction. During receive, the beam former 460 weights and delays the individual receive signals from the corresponding transceiver elements 425 to form a combined receive signal that collectively defines a receive beam that is steered to listen along a select receive line. The beam former 460 repeats the weighting and delaying operation to form multiple separate combined receive signals that each define a corresponding separate receive beam. By adjusting the delays and the weights, the beam former 460 changes the steering angle of the receive beams. The beam former 460 may transmit multiple beams simultaneously during a multiline transmit operation. The beam former 460 may receive multiple beams simultaneously during a multiline receive operation.

### Image Data Conversion Process

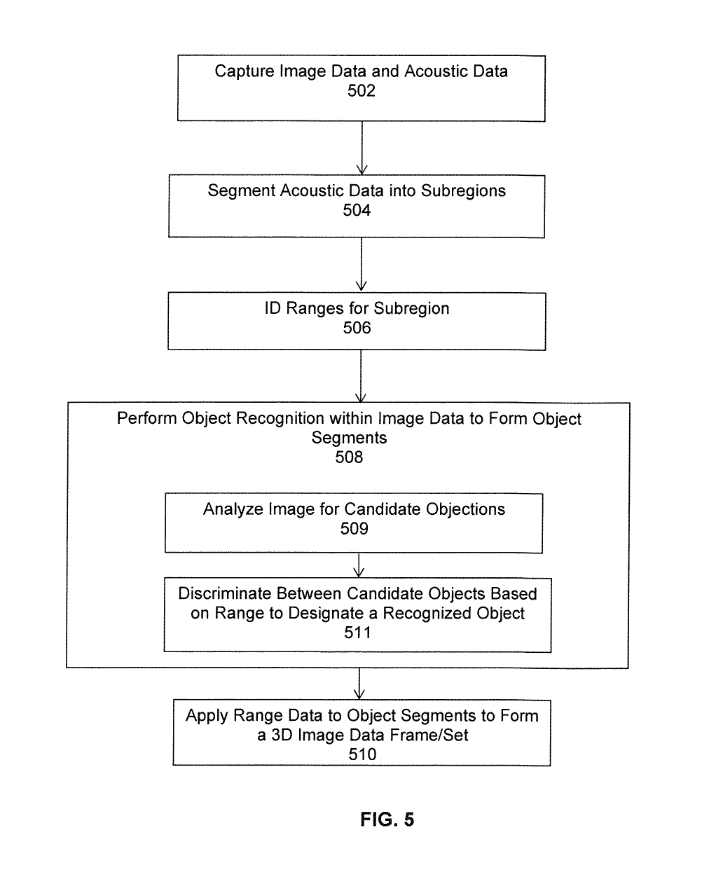

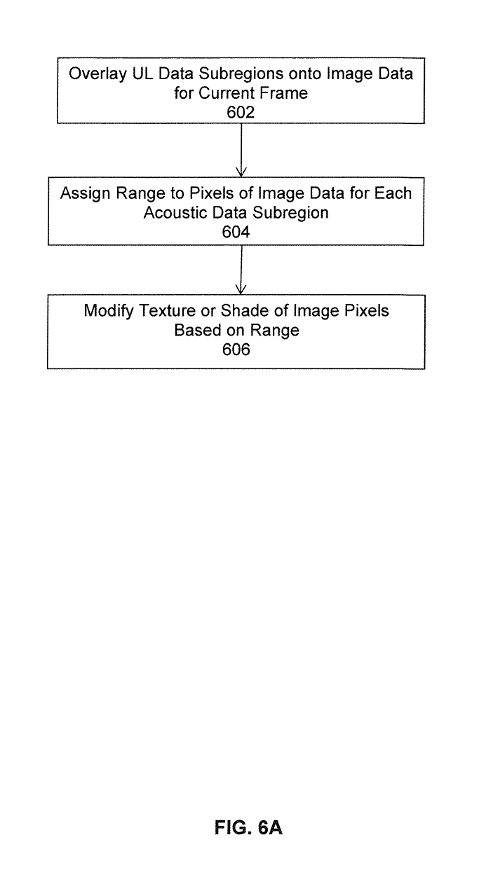

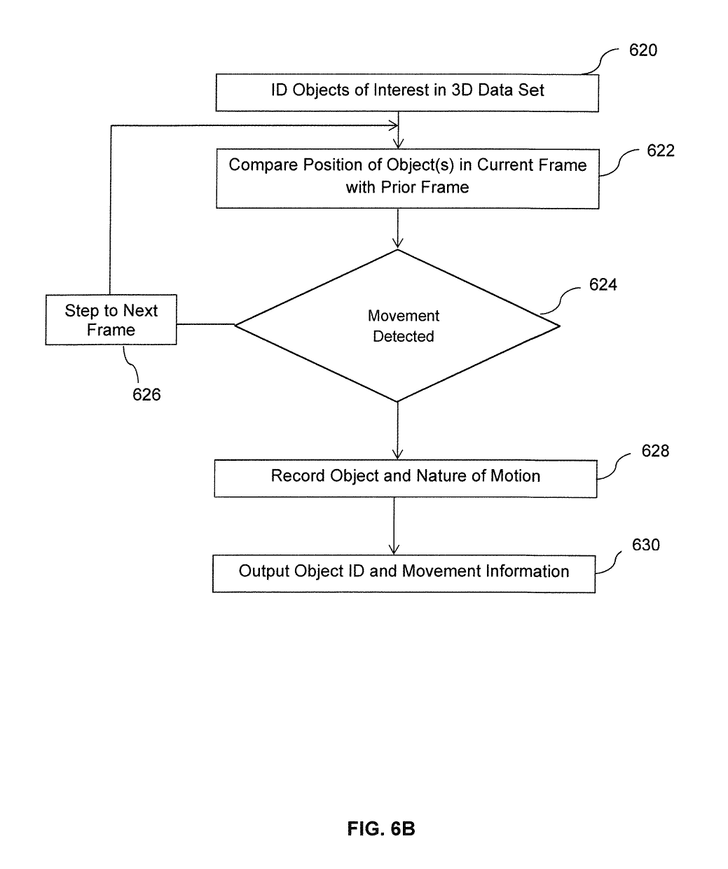

FIG. 5 illustrates a process for generating three-dimensional image data sets in accordance with embodiments herein. The operations of FIGS. 5 and 6 are carried out by one or more processors in FIGS. 1-4 in response to execution of program instructions, such as in the UL-3D application 224, and/or other applications stored in the local storage medium 106, 213. Optionally, all or a portion of the operations of FIGS. 5 and 6 may be carried out without program instructions, such as in an Image Signal Processor that has the corresponding operations implemented in silicon gates and other hardware.

At 502, image data is captured at an image capture device for a scene of interest. The image data may include photographs and/or video recordings captured by a device 102 under user control. For example, a user may direct the lens 114 toward a scene 126 and enter a command at the GUI 108 directing the camera unit 110 to take a photo. The image data corresponding to the scene 126 is stored in the local storage medium 206.

At 502, the acoustic data collector 120 captures acoustic data. To capture acoustic data, the beam former drives the transceivers 118 to transmit one or more acoustic beams into the field of view. The acoustic beams are reflected from objects 128, 130 within the scene 126. Different portions of the objects reflect acoustic signals at different times based on the distance between the device 102 and the corresponding portion of the object. For example, a person's hand and the person's face may be different distances from the device 102 (and lens 114). Hence, the hand is located at a range R1 from the lens 114, while the face is located a range R2 from the lens 114. Similarly, the other objects and portions of objects in the scene 126 are located different distances from the device 102. For example, a building, car, tree or other landscape feature will have one or more portions that are corresponding different ranges Rx from the lens 114.

The beam former manages the transceivers 118 to receive (e.g., listen for) acoustic receive signals (referred to as acoustic receive beams) along select directions and angles within the field of view. The acoustic receive beams originate from different portions of the objects in the scene 126. The beam former processes raw acoustic signals from the transceivers/transducer elements 425 to generate acoustic data (also referred to as acoustic receive data) based on the reflected acoustic. The acoustic data represents information regarding a distance between the image capture device and objects in the scene.

The acoustic data collector 120 manages the acoustic transmit and receive beams to correspond with capture of image data. The camera unit 110 and acoustic data collector 120 capture image data and acoustic data that are contemporaneous in time with one another. For example, when a user presses a photo capture button on the device 102, the camera unit 110 performs focusing operations to focus the lens 114 on one or more objects of interest in the scene. While the camera unit 110 performs a focusing operation, the acoustic data collector 120 may simultaneously transmit one or more acoustic transmit beams toward the field of view, and receive one or more acoustic receive beams from objects in the field of view. In the foregoing example, the acoustic data collector 120 collects acoustic data simultaneously with the focusing operation of the camera unit 110.

Alternatively or additionally, the acoustic data collector 120 may transmit and receive acoustic transmit and receive beams before the camera unit 110 begins a focusing operation. For example, when the user directs the lens 114 on the device 102 toward a scene 126 and opens a camera application on the device 102, the acoustic data collector 120 may begin to collect acoustic data as soon as the camera application is open, even before the user presses a button to take a photograph. Alternatively or additionally, the acoustic data collector 120 may collect acoustic data simultaneously with the camera unit 110 capturing image data. For example, when the camera shutter opens, or a CCD sensor in the camera is activated, the acoustic data collector 120 may begin to transmit and receive acoustic beams.

The camera unit 110 may capture more than one frame of image data, such as a series of images over time, each of which is defined by an image data frame. When more than one frame of image data is acquired, common or separate acoustic data frames may be used for the frame(s). For example, when a series of frames are captured for a stationary landscape, a common acoustic data frame may be applied to one, multiple, or all of the image data frames. When a series of image data frames are captures for a moving object, a separate acoustic data frame will be collected and applied to each of the image data frames. For example, the device 102 may provide the gesture information to the gesture driven/commanded electronic system 103, such as when playing a videogame, controlling a smart TV, making a presentation during an interactive web conferencing event, and the like.

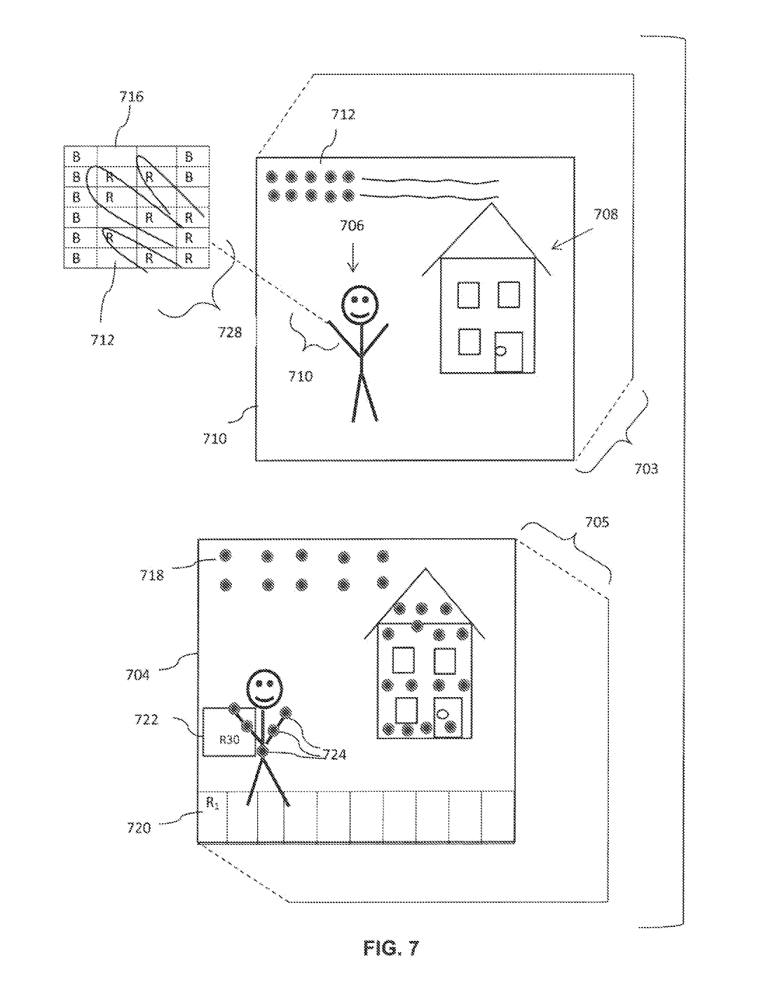

FIG. 7 illustrates a set 703 of image data frames 702 and a set 705 of acoustic data frames 704 collected simultaneously or contemporaneously (e.g., overlapping in time) in connection with movement of an object in a scene. Each image data frame 702 is comprised of image pixels 712 that define objects 706 and 708 in the scene. As explained herein, object recognition analysis is performed upon the image data frame 702 to identify object segments 710. Area 716 illustrates an expanded view of object segment 710 (e.g. a person's finger or part of a hand) which is defined by individual image pixels 712 from the image data frame 702. The image pixels 712 are arranged in a matrix having a select resolution, such as an N×N array.

Returning to FIG. 5, at 504, for each acoustic data frame 705, the process segments the acoustic data frame 704 into subregions 720. The acoustic data frame 704 is comprised of acoustic data points 718 that are arranged in a matrix having a select resolution, such as an M×M array. The resolution of the acoustic data points 718 is much lower than the resolution of the image pixels 712. For example, the image data frame 702 may exhibit a 10 to 20 megapixel resolution, while the acoustic data frame 704 has a resolution of 200 to 400 data points in width and 200 to 400 data points in height over the complete field of view. The resolution of the data points 718 may be set such that one data point 718 is provided for each subregion 720 of the acoustic data frame 704. Optionally, more than one data point 718 may be collected in connection with each subregion 720. By way of example, an acoustic field of view may have an array of 10×10 subregions, an array of 100×100 subregions, and more generally an array of M×M subregions. The acoustic data is captured for a field of view having a select width and height (or radius/diameter). The field of view of the transceiver array 116 is based on various parameters related to the transceivers 118 (e.g., spacing, size, aspect ratio, orientation). The acoustic data is collected in connection with different regions, referred to as subregions, of the field of view.

At 504, the process segments the acoustic data in subregions based on a predetermined resolution or based on a user selected resolution. For example, the predetermined resolution may be based on the resolution capability of the camera unit 110, based on a mode of operation of the camera unit 110 or based on other parameter settings of the camera unit 110. For example, the user may sets the camera unit 110 to enter a landscape mode, an action mode, a “zoom” mode and the like. Each mode may have a different resolution for image data. Additionally or alternatively, the user may manually adjust the resolution for select images captured by the camera unit 110. The resolution utilized to capture the image data may be used to define the resolution to use when segmenting the acoustic data into subregions.

At 506, the process analyzes the one or more acoustic data points 718 associated with each subregion 720 and designates a range in connection with each corresponding subregion 720. In the example of FIG. 7, each subregion 720 is assigned a corresponding range R1, . . . R30, . . . , R100. The ranges R1-R100 are determined based upon the acoustic data points 718. For example, a range may be determined based upon the speed of sound and a time difference between a transmit time, Tx, and a receive time Rx. The transmit time Tx corresponds to the point in time at which a acoustic transmit beam is fired from the transceiver array 116, while the received time Rx corresponds to the point in time at which a peak or spike in the acoustic combined signal is received at the beam former 460 for a receive beam associated with a particular subregion.

The time difference between the transmit time Tx and the received time Rx represents the round-trip time interval. By combining the round-trip time interval and the speed of sound, the distance between the transceiver array 116 and the object from which the acoustic was reflected can be determined as the range. For example, the approximate speed of sound in dry (0% humidity) air, is approximately 331.3 meters per second. If the round-trip time interval between the transmit time and received is time calculated to be 3.02 ms, the object would be approximately 5 m away from the transceiver array 116 and lens 114 (e.g., 0.0302×331.3=10 meters for the acoustic round trip, and 10/2=5 meters one way). Optionally, alternative types of solutions may be used to derive the range information in connection with each subregion.

In the example of FIG. 7, acoustic signals are reflected from various points on the body of the person in the scene. Examples of these points are noted at 724 which corresponds to range values. Each range value 724 on the person corresponds to a range that may be determined from acoustic signals reflecting from the corresponding area on the person/object. The processor 104, 211 analyzes the acoustic data for the acoustic data frame 704 to produce at least one range value 724 for each subregion 720.

The operations at 504 and 506 are performed in connection with each acoustic data frame over time, such that changes in range or depth (Z direction) to one or more objects may be tracked over time. For example, when a user holds up a hand to issue a gesture command for a videogame or television, the gesture may include movement of the user's hand or finger toward or away from the television screen or video screen. The operations at 504 and 506 detect these changes in the range to the finger or hand presenting the gesture command. The changes in the range may be combined with information in connection with changes of the hand or finger in the X and Y direction to afford detailed information for object movement in three-dimensional space.

At 508, the process performs object recognition and image segmentation within the image data to form object segments. A variety of object recognition algorithms exist today and may be utilized to identify the portions or segments of each object in the image data. Examples include edge detection techniques, appearance-based methods (edge matching, divide and conquer searches, grayscale matching, gradient matching, histograms, etc.), feature-based methods (interpretation trees, hypothesis and testing, pose consistency, pose clustering, invariants, geometric hashing, scale invariant feature transform (SIFT), speeded up robust features (SURF) etc.). Other object recognition algorithms may be used in addition or alternatively. In at least certain embodiments, the process at 508 partitions that the image data into object segments, where each object segment may be assigned a common or a subset of range values.

In the example of FIG. 7, the object/fingers may be assigned distance information, such as one range (R). The image data comprises pixels 712 grouped into pixel clusters 728 aligned with the sub-regions 720. Each pixel is assigned the range (or more generally information) associated with the sub-region 720 aligned with the pixel cluster 728. Optionally, more than one range may be designated in connection with each subregion. For example, a subregion may have assigned thereto, two ranges, where one range (R) corresponds to an object within or passing through the subregion, while another range corresponds to background (B) within the subregion. In the example of FIG. 7, in the subregion corresponding to area 716, the object/fingers may be assigned one range (R), while the background outside of the border of the fingers is assigned a different range (B).

Optionally, as part of the object recognition process at 508, the process may identify object-related data within the image data as candidate object at 509 and modify the object-related data based on the range. At 509, an object may be identified as one of multiple candidate objects (e.g., a hand, a face, a finger). The range information is then used to select/discriminate at 511 between the candidate objects. For example, the candidate objects may represent a face or a hand. However, the range information indicates that the object is only a few inches from the camera. Thus, the process recognizes that the object is too close to be a face. Accordingly, the process selects the candidate object associated with a hand as the recognized object.

At 510, process applies information regarding distance (e.g., range data) to the image data to form a 3-D image data frame. For example, the range values 724 and the values of the image pixels 712 may be supplied to a processor 104 or chip set 219 that updates the values of the image pixels 712 based on the range values 724 to form the 3D image data frame. Optionally, the acoustic data (e.g., raw acoustic data) may be combined (as the information) with the image pixels 712, where the acoustic data is not first analyzed to derive range information therefrom. The process of FIG. 5 is repeated in connection with multiple image data frames and a corresponding number of acoustic data frames to form a 3-D image data set. The 3-D image data set includes a plurality of 3-D image frames. Each of the 3-D image data frames includes color pixel information in connection with three-dimensional position information, namely X, Y and Z positions relative to the reference coordinate system 109 for each pixel.

FIG. 6A illustrates the process performed at 510 in accordance with embodiments herein to apply range data (or more generally distance information) to object segments of the image data. At 602, the processor overlays the pixels 712 of the image data frame 710 with the subregion 720 of the acoustic data frame 704. At 604, the processor assigns the range value 724 to the image pixels 712 corresponding to the object segment 710 within the subregion 720. Alternatively or additionally, the processor may assign the acoustic data from the subregion 720 to the image pixels 712. The assignment at 604 combines image data, having color pixel information in connection with two-dimensional information, with acoustic data, having depth information in connection with two-dimensional information, to generate a color image having three-dimensional position information for each pixel.

At 606, the processor modifies the texture, shade or other depth related information within the image pixels 712 based on the range values 724. For example, a graphical processing unit (GPU) may be used to add shading, texture, depth information and the like to the image pixels 712 based upon the distance between the lens 114 and the corresponding object segment, where this distances indicated by the range value 724 associated with the corresponding object segment. Optionally, the operation at 606 may be omitted entirely, such as when the 3-D data sets are being generated in connection with monitoring of object motion as explained below in connection with FIG. 6B.

FIG. 6B illustrates a process for identifying motion of objects of interest within a 3-D image data set in accordance with embodiments herein. Beginning at 620, the method accesses the 3-D image data set and identifies one or more objects of interest within one or more 3-D image data frames. For example, the method may begin by analyzing a reference 3-D image data frame, such as the first frame within a series of frames. The method may identify one or more objects of interest to track within the reference frame. For example, when implemented in connection with gesture control of a television or videogame, the method may search for certain types of objects to be tracked, such as hands, fingers, legs, a face and the like.

At 622, the method compares the position of one or more objects in a current frame with the position of the one or more objects in a prior frame. For example, when the method seeks to track movement of both hands, the method may compare a current position of the right hand at time T2 to the position of the right hand at a prior time T1. The method may compare a current position of the left hand at time T2 to the position of the left hand at a prior time T1. When the method seeks to track movement of each individual finger, the method may compare a current position of each finger at time T2 with the position of each finger at a prior time T1.

At 624, the method determines whether the objects of interest have moved between the current frame and the prior frame. If not, flow advances to 626 where the method advances to the next frame in the 3-D data set. Following 626, flow returns to 622 and the comparison is repeated for the objects of interest with respect to a new current frame.

At 624, when movement is detected, flow advances to 628. At 628, the method records an identifier indicative of which object moved, as well as a nature of the movement associated therewith. For example, movement information may be recorded indicating that an object moved from an XYZ position in a select direction, by a select amount, at a select speed and the like.

At 630, the method outputs an object identifier uniquely identifying the object that has moved, as well as motion information associated therewith. The motion information may simply represent the prior and current XYZ positions of the object. The motion information may be more descriptive of the nature of the movement, such as the direction, amount and speed of movement.

The operations at 620-630 may be iteratively repeated for each 3-D data frame, or only a subset of data frames. The operations at 620-630 may be performed to track motion of all objects within a scene, only certain objects or only reasons. The device 102 may continuously output object identification and related motion information. Optionally, the device 102 may receive feedback and/or instruction from the gesture command based electronic system 103 (e.g. a smart TV, a videogame, a conferencing system) directing the device 102 to only provide object movement information for certain regions or certain objects which may change over time.

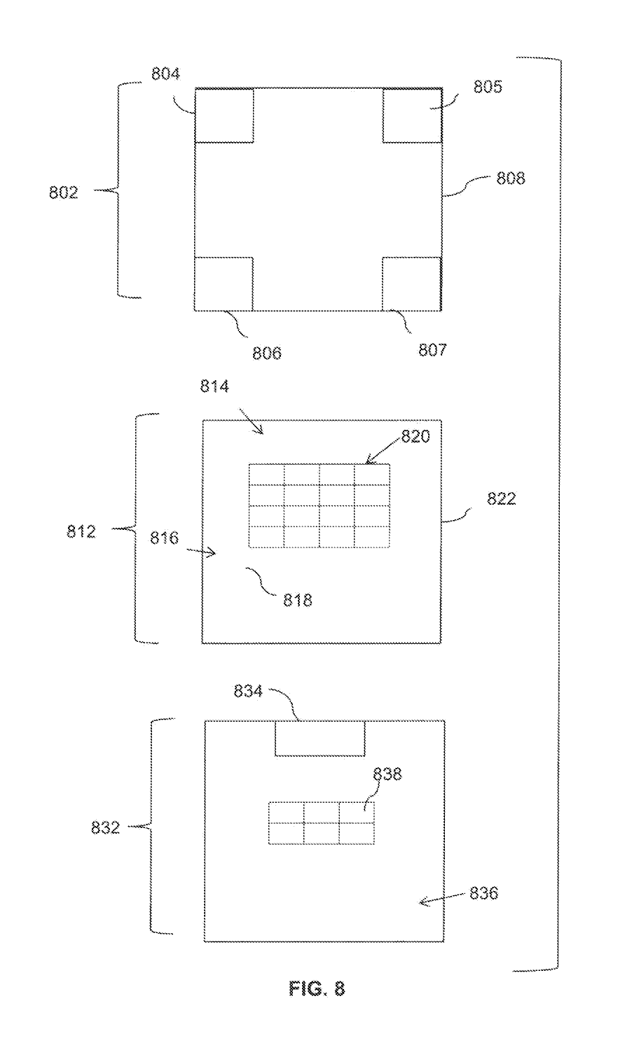

FIG. 8 illustrates alternative configurations for the transceiver array in accordance with alternative embodiments. In the configuration 802, the transceiver array may include transceiver elements 804-807 that are spaced apart and separated from one another, and positioned in the outer corners of the bezel on the housing 808 of a device. By way of example, transceiver elements 804 and 805 may be configured to transmit, while all four elements 804-807 may be configured to receive. Alternatively, one element, such as transceiver element 804 may be dedicated as an omnidirectional transmitter, while transceiver elements 805-807 are dedicated as receive elements. Optionally, two or more transceiver element may be positioned at each of the locations illustrated by transceiver elements 805-807. For example, 2-4 transceiver elements may be positioned at the location of transceiver element 804. A different or similar number of transceiver elements may be positioned at the locations of transceiver elements 805-807.

In the configuration of 812, the transceiver array 814 is configured in a two-dimensional array with 816 of transceiver elements 818 and four columns 820 a transceiver elements 818. The transceiver array 814 includes, by way of example only, 16 transceiver elements 818. All or a portion of the transceiver elements 818 may be utilized during the receive operations. All or a portion of the transceiver elements 818 may be utilized during the transmit operations. The transceiver array 814 may be positioned at an intermediate point within a side of the housing 822 of the device. Optionally, the transceiver array 814 may be arranged along one edge, near the top or bottom or in any corner of the housing 822.

In the configuration at 832, the transceiver array is configured with a dedicated omnidirectional transmitter 834 and an array 836 of receive transceivers 838. The array 836 includes two rows with three transceiver elements 838 in each row. Optionally, more or fewer transceiver elements 838 may be utilized in the receive transceiver 836.

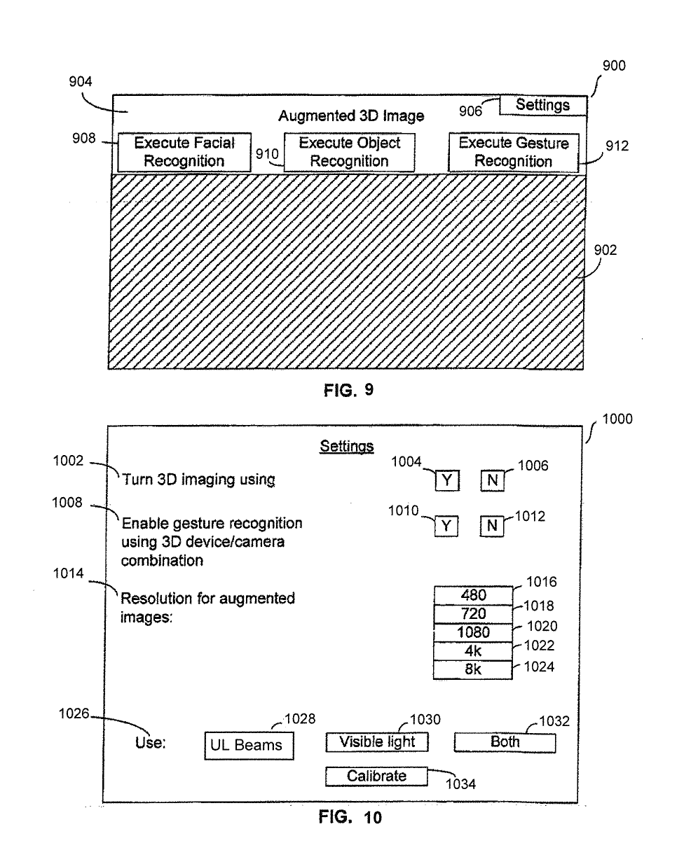

Continuing the detailed description in reference to FIG. 9, it shows an example UI 900 presented on a device such as the system 100. The UI 900 includes an augmented image in accordance with embodiments herein understood to be represented on the area 902, and also an upper portion 904 including plural selector elements for selection by a user. Thus, a settings selector element 906 is shown on the portion 904, which may be selectable to automatically without further user input responsive thereto cause a settings UI to be presented on the device for configuring settings of the camera and/or 3D imaging device, such as the settings UI 1000 to be described below.

Another selector element 908 is shown for e.g. automatically without further user input causing the device to execute facial recognition on the augmented image to determine the faces of one or more people in the augmented image. Furthermore, a selector element 910 is shown for e.g. automatically without further user input causing the device to execute object recognition on the augmented image 902 to determine the identity of one or more objects in the augmented image. Still another selector element 912 for e.g. automatically without further user input causing the device to execute gesture recognition on one or more people and/or objects represented in the augmented image 902 and e.g. images taken immediately before and after the augmented image.

Now in reference to FIG. 10, it shows an example settings UI 1000 for configuring settings of a system in accordance with embodiments herein. The UI 1000 includes a first setting 1002 for configuring the device to undertake 3D imaging as set forth herein, which may be so configured automatically without further user input responsive to selection of the yes selector element 1004 shown. Note, however, that selection of the no selector element 1006 automatically without further user input configures the device to not undertake 3D imaging as set forth herein.

A second setting 1008 is shown for enabling gesture recognition using e.g. acoustic pulses and images from a digital camera as set forth herein, which may be enabled automatically without further user input responsive to selection of the yes selector element 1010 or disabled automatically without further user input responsive to selection of the no selector element 1012. Note that similar settings may be presented on the UI 1000 for e.g. object and facial recognition as well, mutatis mutandis, though not shown in FIG. 7.

Still another setting 1014 is shown. The setting 1014 is for configuring the device to render augmented images in accordance with embodiments herein at a user-defined resolution level. Thus, each of the selector elements 1016-1024 are selectable to automatically without further user input responsive thereto to configure the device to render augmented images in the resolution indicated on the selected one of the selector elements 1016-1024, such as e.g. four hundred eighty, seven hundred twenty, so-called “ten-eighty,” four thousand, and eight thousand.

Still in reference to FIG. 10, still another setting 1026 is shown for configuring the device to emit acoustic beams in accordance with embodiments herein (e.g. automatically without further user input based on selection of the selector element 1028). Last, note that a selector element 1034 is shown for automatically without further user calibrating the system in accordance with embodiments herein.

Without reference to any particular figure, it is to be understood by actuating acoustic beams and determine a distance in accordance with embodiments herein, and also by actuating a digital camera, an augmented image may be generated that has a relatively high resolution owing to use of the digital camera image but also having relatively more accurate and realistic 3D representations as well.

Furthermore, this image data may facilitate better object and gesture recognition. Thus, e.g. a device in accordance with embodiments herein may determine that an object in the field of view of an acoustic rangerfinder device is a user's hand at least in part owing to the range determined from the device to the hand, and at least in part owing to use a digital camera to undertake object and/or gesture recognition to determine e.g. a gesture in free space being made by the user.

Additionally, it is to be understood that in some embodiments an augmented image need not necessarily be a 3D image per se but in any case may be e.g. an image having distance data applied thereto as metadata to thus render the augmented image, where the augmented image may be interactive when presented on a display of a device so that a user may select a portion thereof (e.g. an object shown in the image) to configure a device presenting the augmented image (e.g. using object recognition) to automatically provide an indication to the user (e.g. on the display and/or audibly) of the actual distance from the perspective of the image (e.g. from the location where the image was taken) to the selected portion (e.g. the selected object shown in the image). What's more, it may be appreciated based on the foregoing that an indication of the distance between two objects in the augmented image may be automatically provided to a user based on a user selecting a first of the two objects and then selecting a second of the two objects (e.g. by touching respective portions of the augmented image as presented on the display that show the first and second objects).

It may now be appreciated that embodiments herein provide for an acoustic chip that provides electronically steered acoustic emissions from one or more transceivers, acoustic data from which is then used in combination with image data from a high-resolution camera such as e.g. a digital camera to provide an augmented 3D image. The range data for each acoustic beam may then combined with the image taken at the same time.

Before concluding, it is to be understood that although e.g. a software application for undertaking embodiments herein may be vended with a device such as the system 100, embodiments herein apply in instances where such an application is e.g. downloaded from a server to a device over a network such as the Internet. Furthermore, embodiments herein apply in instances where e.g. such an application is included on a computer readable storage medium that is being vended and/or provided, where the computer readable storage medium is not a carrier wave or a signal per se.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A method, comprising:
capturing image data at an image capture device for a scene;
collecting acoustic data indicative of information regarding a distance between the image capture device and an object in the scene; and
combining a portion of the image data related to the object with the information to form a 3D image data set.

2. The method of claim 1, further comprising designating a range in connection with the object based on the acoustic data, the range representing at least a portion of the information combined with the image data to form the 3D image data set.

3. The method of claim 1, wherein the information combined with the image data represents the acoustic data as collected.

4. The method of claim 2, further comprising performing object recognition for objects in the image data by:
analyzing the image data for candidate objects;
discriminating between the candidate objects based on the range to designate a recognized object in the image data.

5. The method of claim 2, wherein the image data comprises a matrix of pixels that define an image frame, the method further comprising analyzing the pixels to perform object recognition of objects within the image frame to form object segments within the image frame, the designating operation including associating individual ranges with the corresponding object segments.

6. The method of claim 1, wherein the information comprises a matrix of acoustic ranges within an acoustic data frame, corresponding to a select point in time, each of the acoustic ranges indicative of the distance between the image capture device and the corresponding object.

7. The method of claim 1, further comprising;
segmenting the information into sub-regions, where each of the sub-regions has at least one corresponding range assigned thereto;
overlaying the pixels of the image data and the sub-regions to form pixel clusters associated with the sub-regions; and
assigning ranges to pixel clusters such that each of the pixel clusters is assigned the range associated with a sub-region of the information that overlays the pixel cluster.

8. The method of claim 1, wherein the information comprises sub-regions and wherein the image data comprises pixels grouped into pixel clusters aligned with the sub-regions, assigning to each pixel a range associated with the sub-region aligned with the pixel cluster.

9. The method of claim 1, wherein the 3D image data set includes a plurality of 3D image frames, the method further comprising comparing positions of the objects, based at least in part on the information, between the 3D image frames to identify motion of the objects.

10. The method of claim 1, further comprising detecting a gesture-related movement of the object based at least in part on changes in the information regarding the distance to the object between frames of the 3D image data set.

11. A device, comprising:
a processor;
a digital camera that captures image data for a scene;
a data collector that collects acoustic data indicative of information regarding a distance between the digital camera and an object in the scene;
a local storage medium storing program instructions accessible by the processor;
wherein, responsive to execution of the program instructions, the processor combines the image data related to the object with the information to form a 3D image data set.

12. The device of claim 11, further comprising a housing, the digital camera including a lens, the data collector including a plurality of transceivers, the lens and transceivers mounted in a common side of the housing to be directed in a common viewing direction.

13. The device of claim 11, wherein the data collector including transceivers and a beam former communicatively coupled to the transceivers, the beam former to transmit acoustic beams toward the scene and receive acoustic reflections from the object in the scene, the beam former to generate the acoustic data based on the acoustic reflections.

14. The device of claim 11, wherein the processor designates a range in connection with the object based on the acoustic data, the range representing at least a portion of the information combined with the image data to form the 3D image data set.

15. The device of claim 11, wherein the data collector comprises a beam former configured to direct the transceivers to perform multiline reception along multiple receive beams to collect the acoustic data.

16. The device of claim 11, wherein the data collector aligns transmission and reception of the acoustic transmit and receive beams to occur overlapping in time with collection of the image data.

17. A computer program product comprising a non-signal computer readable storage medium comprising computer executable code to:
capture image data at an image capture device for a scene;
collect acoustic data indicative of a distance between the image capture device and an object in the scene; and
combine a portion of the image data related to the object with the range to form a 3D image data set.

18. The computer program product of claim 17, wherein the non-signal computer readable storage medium comprising computer executable code to designate a range in connection with the object based on the acoustic data.

19. The computer program product of claim 17, wherein the non-signal computer readable storage medium comprising computer executable code to segment the acoustic data into sub-regions of the scene and designate a range for each of the sub-regions.

20. The computer program product of claim 18, wherein the non-signal computer readable storage medium comprising computer executable code to perform object recognition for objects in the image data by:
analyzing the image data for candidate objects;
discriminating between the candidate objects based on the range to designate a recognized object in the image data.
